(19) United States
(12) Patent Application Publication
(10) Pub. No.: US 2017/0014977 A1
(43) Pub. Date: Jan. 19, 2017

(54) SWITCH FOR USE IN A SELECTIVE ONE-WAY WRENCH

(71) Applicant: Hsiu-Hua Chang, Taichung (TW)

(72) Inventor: Hsiu-Hua Chang, Taichung (TW)

(21) Appl. No.: 14/801,082

(22) Filed: Jul. 16, 2015

(51) Int. Cl. B25B 13/46; F16H 53/06

(52) U.S. Cl. CPC B25B 13/463; F16H 53/06

(57) ABSTRACT

A switch includes a body, a pusher and an elastic element. The body includes a cavity including a first portion made therein, a second portion extending to an external face of the body from the first portion, and a shoulder formed between the first portion and the second portion. The pusher includes an expansive end for abutment against the shoulder to keep the pusher on the body and a rounded end extending out of the cavity from the expansive end. The elastic element body presses the expansive end of the pusher against a portion of the body to keep the rounded end of the pusher always out of the cavity.

### BACKGROUND OF INVENTION

1. Field of Invention

The present invention relates to a selective one-way wrench and, more particularly, to a switch for use in a selective one-way wrench.

2. Related Prior Art

Referring to FIGS. 8 and 9, a selective one-way wrench 90 includes a head 92, an annular gear 91, a pawl 95 and a switch 10. The head 92 includes a major circular space 94 in communication with a minor circular space 96 via a crescent space 98. The annular gear 91 includes teeth 93 on the periphery. When the annular gear 91 is rotationally inserted in the major circular space 94, some of the teeth 93 are inserted in the major circular space 94 while the other teeth 93 are inserted in the crescent space 98.

The pawl 95 is a substantially crescent element that includes a toothed front face 97 and a smooth rear face 99. The pawl 95 is inserted in the crescent space 98 so that the front face 97 faces the teeth 93 of the annular gear 91 while the rear face 99 faces the minor circular space 96 of the head 92.

The switch 10 includes a pusher 12, an elastic element 16 and a body 20. The pusher 12 is in the form of a sheath for receiving the elastic element 16 that is in the form of a compression spring. The pusher 12 and the elastic element 16 are inserted in a cavity 22 made in the body 20.

The switch 10 is pivotally inserted the minor circular space 96 of the head 92 so that the pusher 12 is in contact with the rear face 99 of the pawl 95. The pusher 12 forces the pawl 95, which is retained in the crescent space 98, to engage with the teeth 93 of the annular gear 91. Thus, determined is an operative direction of the selective one-way wrench 90 in which the head 92 transfers torque to the annular gear 91 via the pawl 95.

The cavity 22 is made with a diameter that is constant throughout its length. The pusher 12 is shaped like a bullet and made with a diameter smaller than that of the cavity 22. Hence, the elastic element 16 tends to push the pusher 12 out of the cavity 22 of the body 20, and this interferes with the insertion of the switch 10 in the minor circular space 96 of the head 92 and the insertion of the annular gear 91 and the pawl 95 in the head 92.

The present invention is therefore intended to obviate or at least alleviate the problems encountered in prior art.

### SUMMARY OF INVENTION

It is the primary objective of the present invention to provide a switch that can easily be located in a wrench.

To achieve the foregoing objectives, the switch includes a body, a pusher and an elastic element. The body includes a cavity including a first portion made therein, a second portion extending to an external face of the body from the first portion, and a shoulder formed between the first portion and the second portion. The pusher includes an expansive end for abutment against the shoulder to keep the pusher on the body and a rounded end extending out of the cavity from the expansive end. The elastic element body presses the expansive end of the pusher against a portion of the body to keep the rounded end of the pusher always out of the cavity.

Other objectives, advantages and features of the present invention will be apparent from the following description referring to the attached drawings.

### BRIEF DESCRIPTION OF DRAWINGS

The present invention will be described via detailed illustration of three embodiments referring to the drawings wherein:

FIG. 1 is an exploded view of a switch according to the first embodiment of the present invention;

FIG. 2 is a perspective view of the switch shown in FIG. 1;

FIG. 3 is a cross-sectional view of the switch shown in FIG. 2;

FIG. 4 is a cut-away view of the switch shown in FIG. 2;

FIG. 5 is another cross-sectional view of the switch shown in FIG. 2;

FIG. 6 is a cross-sectional view of a switch according to the second embodiment of the present invention;

FIG. 7 is a cut-away view of according to the third embodiment of the present invention;

FIG. 8 is an exploded view of a conventional switch; and

FIG. 9 is a cross-sectional view of the switch shown in FIG. 8.

### DETAILED DESCRIPTION OF EMBODIMENTS

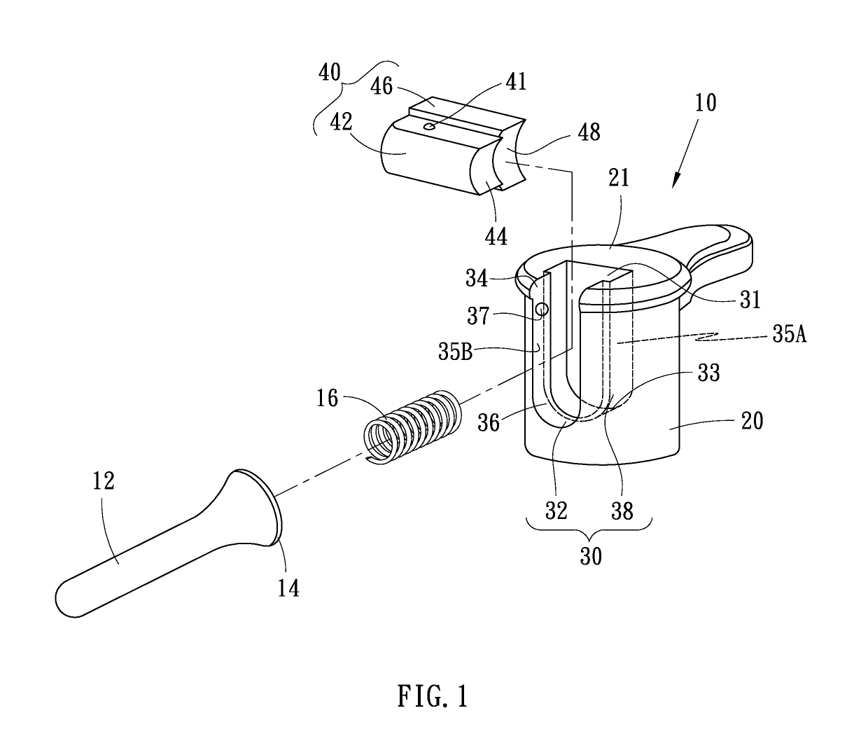

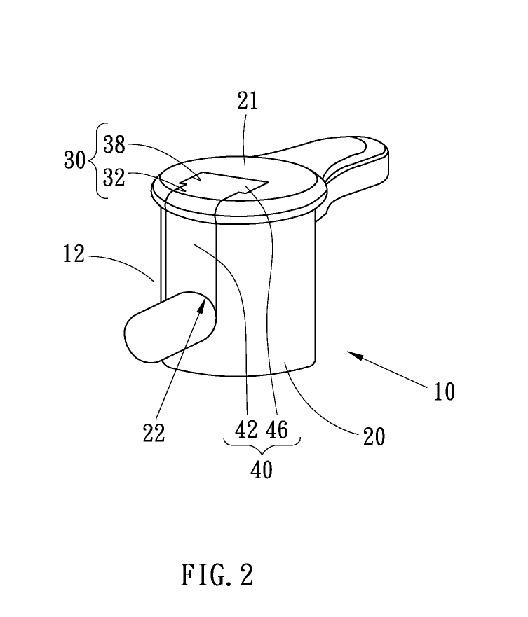

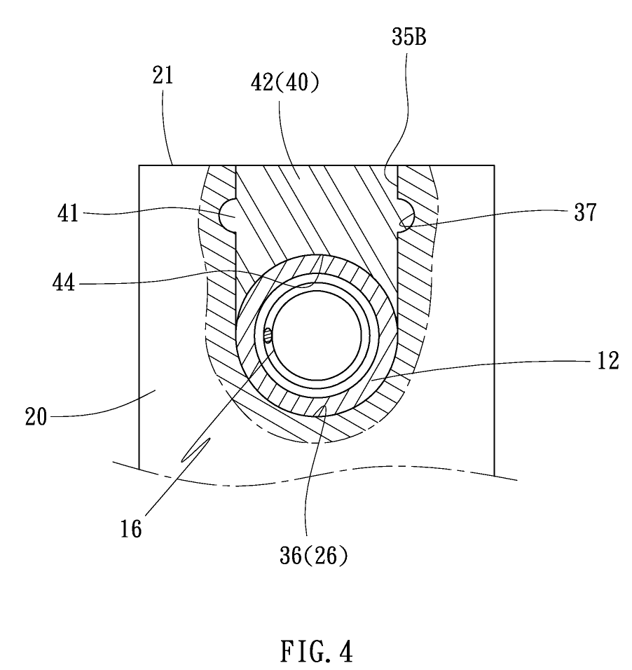

Referring to FIGS. 1 to 4, a switch 10 includes a body 20, a pusher unit and a lock 40 according to a first embodiment of the present invention. The body 20 is a cylindrical element that includes a cutout 30 made in an upper side 21 and the periphery. The cutout 30 is a T-shaped cutout that includes a first portion 38 and a second portion 32 narrower than the first portion 38.

The first portion 38 of the cutout 30 includes an opening 31 in the upper side 21 of the body 20, a concave face 33 opposite to the opening 31, and two lateral walls 35A extending parallel to each other. Each of the lateral walls 35A extends to concave face 33 from the opening 31. The distance between the lateral walls 35A is the width of the first portion 38 of the cutout 30.

The second portion 32 of the cutout 30 includes an opening 34 in the upper side 21 of the body 20, a concave face 36 opposite to the opening 34, and two lateral walls 35B extending parallel to each other. The concave face 36 is made with a diameter smaller than that of the concave face 33. The concave face 36 is located lower than the concave face 36. Each of the lateral walls 35B extends to the concave face 36 from the opening 34. The distance between the lateral walls 35B is the width of the second portion 32 of the cutout 30. The width of the second portion 32 of the cutout 30 is smaller than that of the first portion 38 of the cutout 30.

The lock 40 is a T-shaped element shaped in compliance with the cutout 30. The lock 40 is formed with a narrow portion 42 and a wide portion 46.

The narrow portion 42 of the lock 40 is made with a width identical to that of the second portion 32 of the cutout 30. The narrow portion 42 of the lock 40 includes a concave face 44 at a lower end and two bosses 41 on two opposite sides. The concave face 44 is made with a diameter identical to that of the concave face 36.

The wide portion 46 of the lock 40 is made with a width identical to that of the first portion 38 of the cutout 30. The wide portion 46 of the lock 40 includes a concave face 48 at a lower end. The concave face 48 is made of a diameter identical to that of the concave face 33.

The lock 40 is inserted in the cutout 30, with the wide portion 46 of the former inserted in the first portion 38 of the latter and the narrow portion 42 of former inserted in the second portion 32 of the latter. The concave face 48 cooperates with the concave face 33 to make a first portion 24 of a cavity 22. The concave face 44 cooperates with the concave face 36 to make a second portion 26 of the cavity 22. The bosses 41 of the lock 40 are inserted in the recesses 37 of the lateral walls 35B, thus detachably connecting the lock 40 to the body 20.

The first portion 24 of the cavity 22 is a closed one while the second portion 26 of the cavity 22 is an open one. The cavity 22 receives the pusher unit. The first portion 24 of the cavity 22 is made with a diameter larger than that of the second portion 26 of the cavity 22, thus forming a shoulder 28 between them.

The pusher unit includes a pusher 12 biased by an elastic element 16. The pusher 12 is in the form of a sheath. The pusher 12 includes a rounded end and an expansive end 14 opposite to the rounded end. The pusher 12 is made with a bore 18 that includes a closed end and an open end. The elastic element 16 is preferably in the form of a compression spring. The elastic element 16 can however be in the form of a leaf spring or made of elastomer.

The cavity 22 receives the pusher 12 and the elastic element 16. The pusher 12 is movable in the second portion 26 of the cavity 22. The expansive end 14 of the pusher 12 is confined in the first portion 24 of the cavity 22 by the shoulder 28. That is, the connection of the pusher unit to the body 20 is retained. The elastic element 16 is inserted in the bore 18 of the pusher 12. An end of the elastic element 16 is in contact with the interior of the pusher 12 while another end of the elastic element 16 is in contact with a portion of the body 20 that closes the first portion 24 of the cavity 22. Thus, the elastic element 16 biases the pusher 12 to keep the rounded end of the pusher 12 out of the cavity 22 all the time.

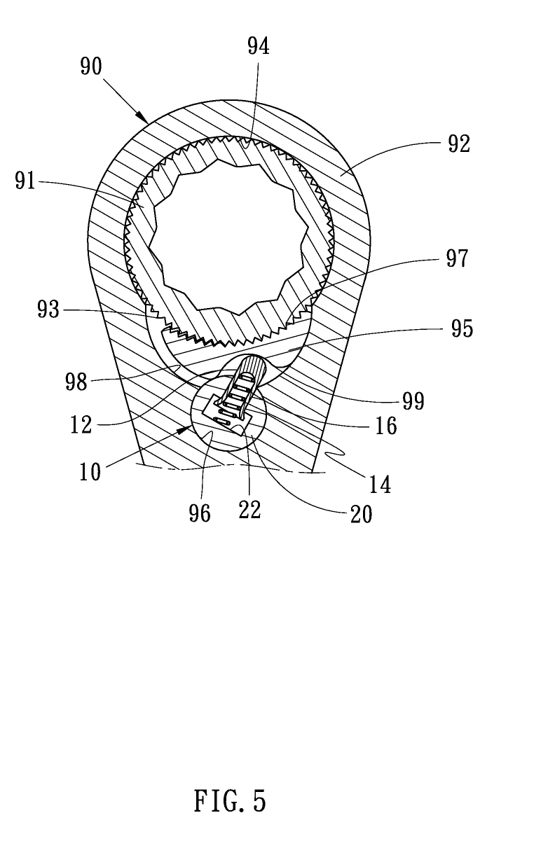

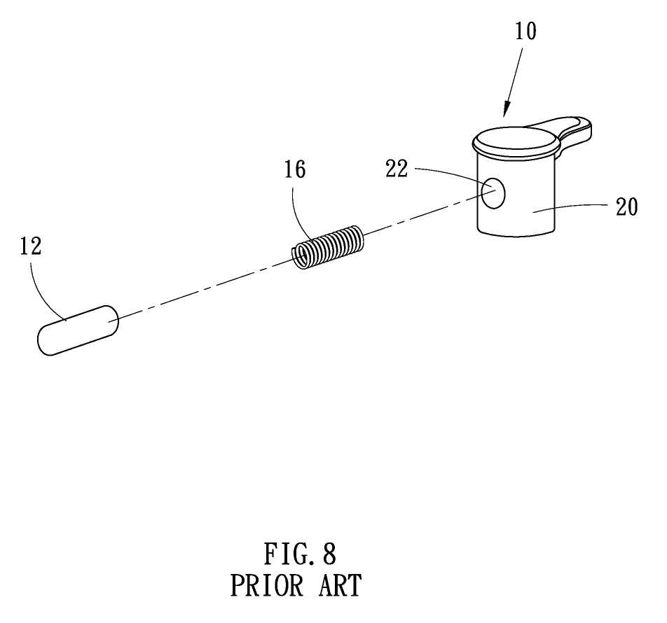

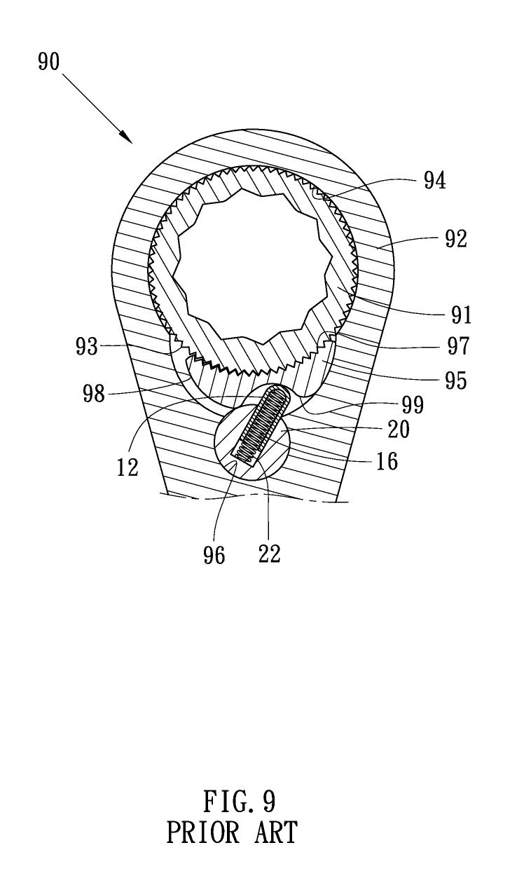

Referring to FIG. 5, the switch 10 is used in the selective one-way wrench 90 discussed in the RELATED PRIOR ART referring to FIGS. 8 and 9. In fact, the switch 10 can be used in various selective one-way wrenches. The switch 10 is pivotally inserted in the minor circular space 96. The rounded end of the pusher 12 is in contact with the rear face 99 of the pawl 95. The pusher 12 forces the pawl 95, which is confined in the crescent space 98, to engage with the teeth 93 of the annular gear 91. Thus, determined is the operative direction of the selective one-way wrench 90 in which the head 92 rotates the annular gear 91 via the pawl 95.

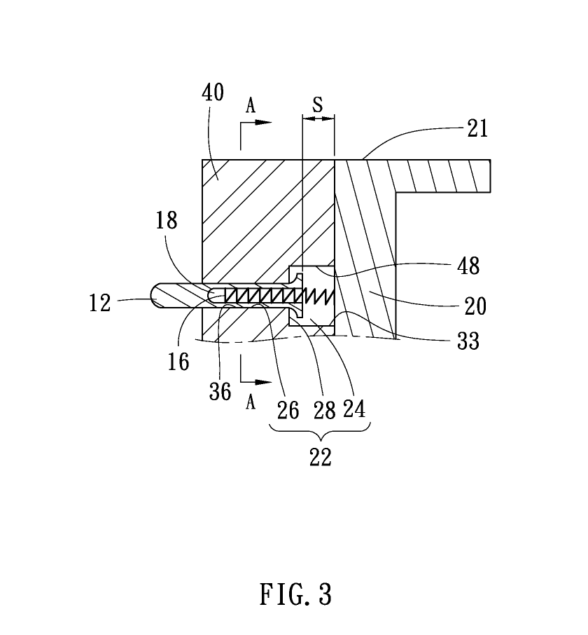

Referring to FIG. 3, there is a gap S between the expansive end 14 of the pusher 12 and the closed end of the cavity 22 of the body 20. Hence, there is enough room for the movement of the pusher 12, without any risk of the elastic element 16 pushing of the pusher 12 completely out of the body 20. Hence, the switch 10, which includes the pusher 12, the elastic element 16, the body 20 and the lock 40, becomes a module that can easily be placed between an internal face of the head 92 and the pawl 95.

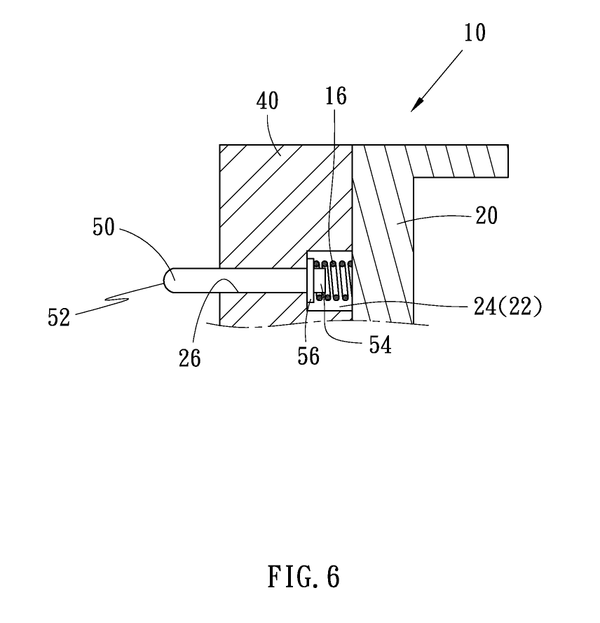

Referring to FIG. 6, there is a switch 10 according to a second embodiment of the present invention. The second embodiment is like the first embodiment except for that the pusher unit includes a pusher 50 instead of the pusher 12. The pusher 50 is substantially in the form of a pusher that includes an annular rib 56 formed between a front section 52 and a rear section 54. The annular rib 56 is used instead of the expansive end 14 of the pusher 12.

The cavity 22 of the body 20 receives the pusher 50 and the elastic element 16. Thus, the rear section 54 of the pusher 50 is movable in the first portion 24 of the cavity 22 while the front section 52 of the annular rib 56 is movable in the second portion 26 of the cavity 22. An end of the elastic element 16 extends around the rear section 54 of the pusher 50 and abuts against the annular rib 56 while the other end of the elastic element 16 abuts against the portion of the body 20 that closes the first portion 24 of the cavity 22. Thus, the elastic element 16 biases the pusher 50 to cause the rounded end of the pusher 50 to extend out of the cavity 22 all the time.

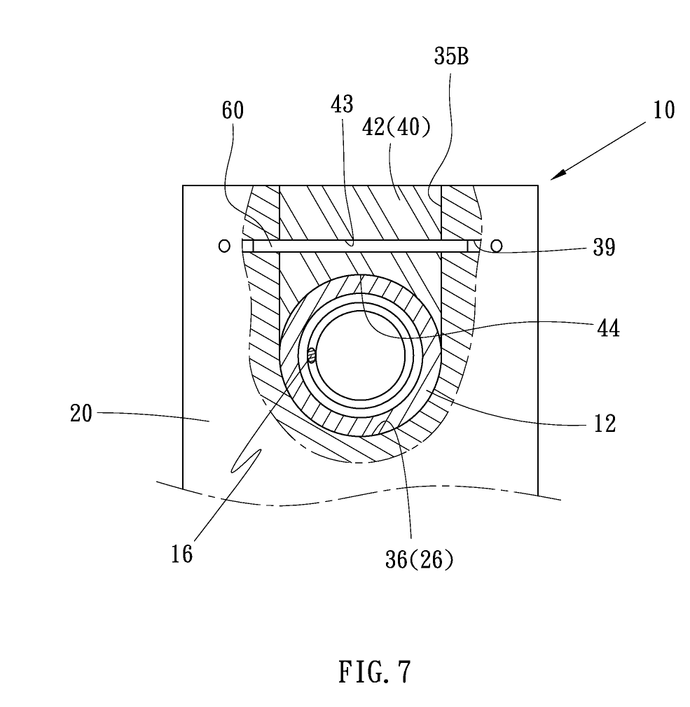

Referring to FIG. 7, there is a switch 10 according to a third embodiment of the present invention. The third embodiment is like the first embodiment except for additionally including a pin 60 to keep the lock 40 on the body 20. The pin 60 is inserted in two apertures 39 made in the body 20 and a tunnel 43 made in the narrow portion 42 (or the wide portion 46) of the lock 40. Each of the apertures 39 is made in a corresponding one of the lateral walls 35B of the body 20.

The present invention has been described via the detailed illustration of the embodiments. Those skilled in the art can derive variations from the embodiments without departing from the scope of the present invention. Therefore, the embodiment shall not limit the scope of the present invention defined in the claims.

1. A switch comprising:
a body comprising a cavity comprising a first portion made therein, a second portion extending to an external face of the body from the first portion, and a shoulder formed between the first portion and the second portion;
a pusher comprising a portion for abutment against the shoulder and a rounded end extending out of the cavity from the expansive end; and
an elastic element body for pressing the portion of the pusher against a portion of the body so that the rounded end of the pusher always extends out of the cavity.

2. The switch according to claim 1, comprising a lock connected to the body so that they together make the cavity.

3. The switch according to claim 2, wherein the body comprises a cutout comprising a first portion made therein and a second portion extending to an external face of the cavity from the first portion, wherein the lock includes a wide portion inserted in the first portion of the cutout and a narrow portion inserted in the second portion of the cutout.

4. The switch according to claim 3, wherein the first portion of the cutout is made with a width larger than that of the second portion of the cutout.

5. The switch according to claim 4, wherein the first portion of the cutout comprises an opening and a concave face opposite to the opening, wherein the second portion of the cutout comprises an opening and a concave face opposite to the opening thereof, wherein the wide portion of the lock comprises a concave face for cooperating with the concave face of the first portion of the cutout to make the first portion of the cavity, wherein the narrow portion of the lock comprises concave face for cooperating with the concave face of the second portion of the cutout to make the second portion of the cavity.

6. The switch according to claim 2, wherein the first portion of the cutout comprises two parallel lateral walls each extending to the concave face thereof from the opening thereof, wherein the distance between lateral walls of the first portion of the cutout is the width of the second portion of the cutout.

7. The switch according to claim 2, wherein the second portion of the cutout comprises two parallel lateral walls each extending to the concave face thereof from the opening thereof, wherein the distance between lateral walls of the second portion of the cutout is the width of the second portion of the cutout.

8. The switch according to claim 3, wherein at least one of the lateral walls of one of the first and second portions of the cutout includes a recess, wherein the corresponding one of the wide and narrow portions of the lock comprises at least one boss inserted in the recess to keep the lock on the body.

9. The switch according to claim 2, comprising a pin inserted in the lock and the body to keep the lock on the body.

10. The switch according to claim 9, wherein the lock comprises a tunnel for receiving the pin, wherein the body comprises at least one aperture for receiving the pin.

11. The switch according to claim 1, wherein the pusher is in the form of a sheath that includes an expansive end for abutment against the shoulder.

12. The switch according to claim 11, wherein the elastic element is in the form of a compression spring that comprises an end inserted in and pressed against the pusher and another end in contact with a portion of the body that closes the first portion of the cavity.

13. The switch according to claim 1, wherein the pusher is in the form of a rod that comprises an annular rib for abutment against the shoulder.

14. The switch according to claim 13, wherein the elastic element is in the form of a compression spring that comprises an end located around the front section of the pusher and pressed against the annular rib and another end in contact with a portion of the body that closes the first portion of the cavity.

15. A selective one-way wrench comprising the switch according to claims 1 to 9, comprising:
a head comprising a major circular space, a minor circular space and a crescent space via which the major and minor circular spaces;
an annular gear rotationally inserted in the major circular space and formed with teeth; and
a pawl comprising a toothed front face for engagement with the teeth of the annular gear and a rear face for abutment against a wall of the minor circular space;
wherein the rounded end of the pusher is pressed against the rear face of the pawl while the body is pivotally inserted in the minor circular space.
